(19) United States
(12) Patent Application Publication
(10) Pub. No.: US 2005/0140095 A1
(43) Pub. Date: Jun. 30, 2005

(54) Insert molded structure and method for the manufacture thereof

(76) Inventors: Anis Muhammad, Mississauga (CA); Thomas F. Seiler, Milton (CA); Brian E. Cheadle, Brampton (CA)

Correspondence Address: DYKEMA GOSSETT PLLC, 39577 WOODWARD AVENUE, SUITE 300, BLOOMFIELD HILLS, MI, 48304-5086, US

(21) Appl. No.: 11/011,929

(22) Filed: Dec. 14, 2004

(30) Foreign Application Priority Data
Dec. 29, 2003 (CA) 2,454,283

(51) Int. Cl. F16J 15/32

(52) U.S. Cl. 277/575

(57) ABSTRACT

An insert molded structure has a compressed O-ring seal on an inner end portion of an insert member such as a metal tubular member, a wall of, for example, an injection molded housing of plastic material partially encapsulating the O-ring seal and the inner end portion of the tubular member and maintaining the O-ring seal in radial compression.

This application claims priority from Canadian Patent application No. 2,454,283 filed Dec. 29, 2003.

### FIELD OF THE INVENTION

This invention relates to insert molded structures and methods for the manufacture thereof, and in particular to structures where inserts are encapsulated, at least partially, in a molded material.

### BACKGROUND OF THE INVENTION

U.S. Patent No. 4,214,781 to Joseph discloses a pipe joint in which an end portion of a metal pipe is inserted into an aperture in a molded housing. The end portion of the metal pipe has an annular rib, and an O-ring seal is located between the annular rib and the housing. A metal eyelet is molded into the molded housing and is swaged over the rib to hold the O-ring in compression. A difficulty with such structures, however, is that it is difficult to get a good leak-proof joint by such swaging methods.

### SUMMARY OF THE INVENTION

The present invention provides an improved insert molded structure in which an insert member and a surrounding wall are maintained in substantially fluid-tight sealing relationship.

In accordance with one aspect of the present invention there is provided an insert molded structure comprising an insert member having an inner end portion, a compressed O-ring seal mounted on said inner end portion, and a wall formed of a molded material which partially encapsulates the O-ring seal and said inner end portion and which maintains the O-ring seal in compression.

In accordance with a further aspect of the present invention there is provided a method of attaching an insert member to a wall, comprising the steps of providing an insert member having an inner end portion, mounting an O-ring seal on said inner end portion, and forming the wall by molding material around the O-ring seal to partially encapsulate and compress the O-ring seal and maintain the O-ring seal in compression.

### BRIEF DESCRIPTION OF THE DRAWINGS

In order that the invention may be more clearly understood and more readily carried into effect the same will now, by way of example, be more fully described with reference to the accompanying drawings in which:

FIG. 1 is an elevational view, partly in cross-section, of an insert molded structure according to a preferred embodiment of the present invention;

FIG. 2 is a top plan view of the insert molded structure taken in the direction of arrow A in FIG. 1;

FIG. 3 is a side view of the insert molded structure taken in the direction of arrow B in FIG. 1;

FIG. 4 is a view on an enlarged scale of one of the tubular members incorporated in the insert molded structure shown in FIG. 1;

FIG. 5 is a view of an insert molded structure according to an alternative embodiment of the present invention; and

FIG. 6 is a view of an insert molded structure according to a further alternative embodiment of the present invention.

### DETAILED DESCRIPTION OF PREFERRED EMBODIMENTS

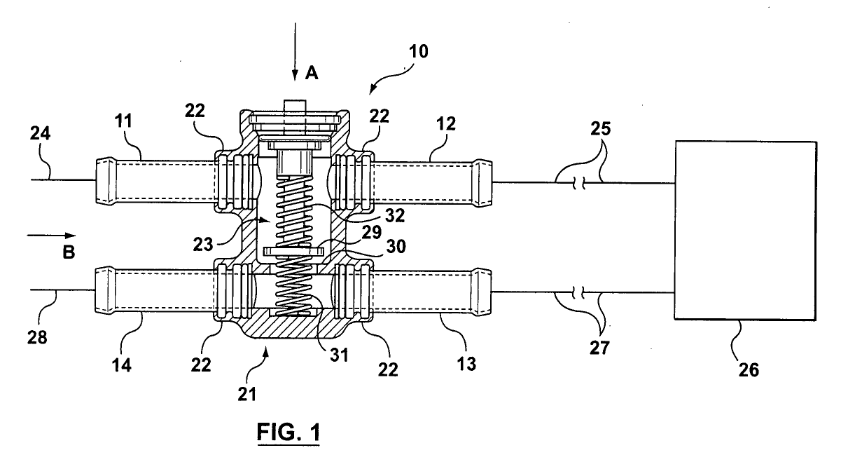

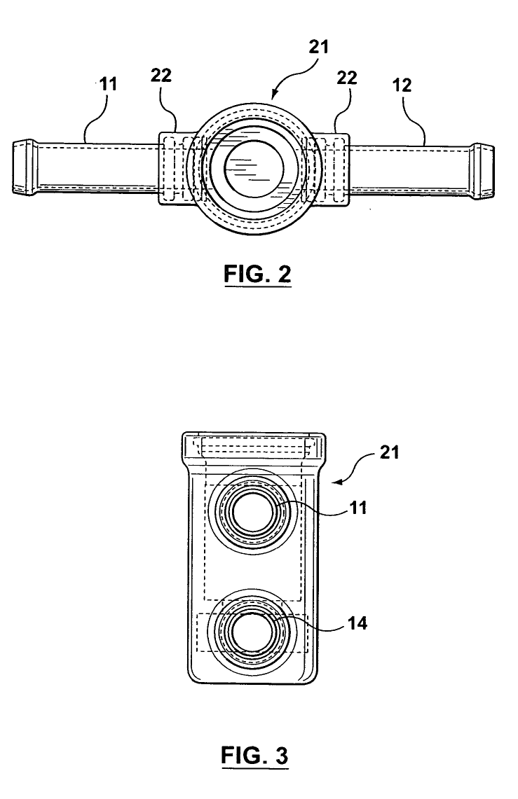

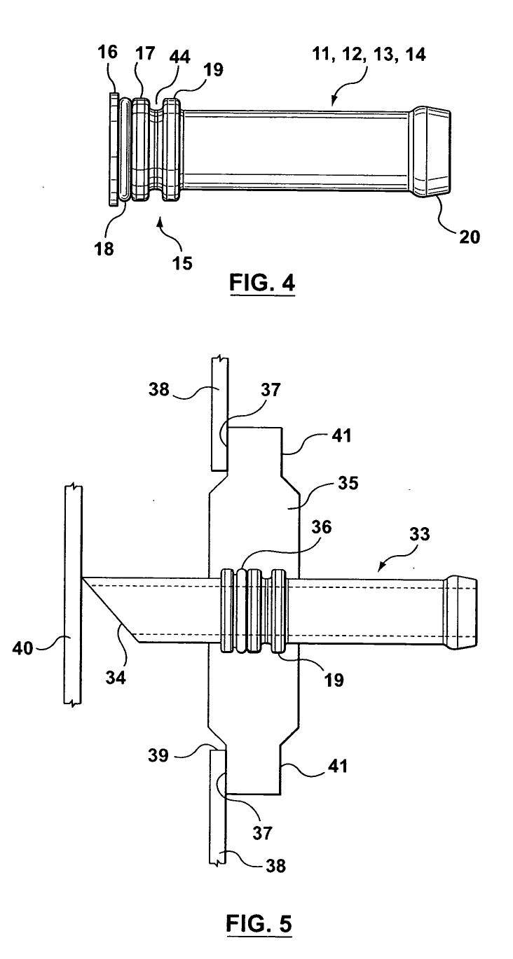

Referring to FIGS. 1 to 4, inclusive, of the drawings, 10 denotes generally an insert molded structure which comprises four insert members constituted by tubular members, namely, an inlet feed oil tube 11, an outlet feed oil tube 12, an inlet return oil tube 13, and an outlet return oil tube 14. These tubes 11, 12, 13 and 14 are of identical form in the preferred embodiments shown in the drawings. As is most clearly shown in FIG. 4, each tube 11, 12, 13 and 14 has an inner end portion 15 which is provided at the distal end thereof with a radially outwardly projecting flange or rib 16 and another radially outwardly projecting rib 17 longitudinally spaced from rib 16. An O-ring seal 18 is mounted on the inner end portion 15 between the ribs 16 and 17. The inner end portion 15 is also preferably formed with at least one further radially outwardly projecting rib 19 which is longitudinally spaced from ribs 16 and 17. The form and dimensions of rib 19 may correspond to those of rib 17, thereby to provide a groove 44 between the rib 19 and the rib 17. In the preferred embodiments shown in the drawings, the outer end portion of each tube 11, 12, 13 and 14 is formed with an annular bulbous portion 20 to facilitate mounting thereto an end portion of, for example, an oil line 24, 25, 27 and 28, respectively. While as shown in the drawings, the tubes 11, 12, 13 and 14 are of circular form in transverse cross-section, it will be appreciated that these tubes 11, 12, 13 and 14, or at least portions of them, could be of other form such as, for example, hexagonal form in transverse cross-section.

With further reference to FIGS. 1, 2 and 3, 21 denotes generally a housing which is formed of a moldable material such as a plastic material which may be a thermoplastic or a thermosetting material and which may contain reinforcement such as glass fibre or particulate reinforcement. The tubes 11, 12, 13 and 14, which are preferably of metal such as, for example, aluminum, steel, brass or copper alloy, are usually made of a material having a different coefficient of thermal expansion than the material of the housing 21. The housing 21 is formed with a wall which, in the preferred embodiments shown in the drawings, is constituted by a socket 22 for the inner end portion 15 of each of the tubes 11, 12, 13 and 14. The housing 21 is formed by injection molding the moldable material with the molded material in each socket 22 partially encapsulating the O-ring seal 18 in that the O-ring seal 18 is a snug fit in the groove between the ribs 16 and 17 with the molded material in contact with the outer peripheral face of the O-ring seal 18. The molded material also encapsulates the inner end portion 15 of the respective tube 11, 12, 13 and 14 including the rib 19 although, for example, the radially outward portion of this rib 19 could be exposed so that this rib 19 is only partially encapsulated by the molded material. The moldable material is injection molded at a pressure which results in the moldable material radially compressing the O-ring seal 18. During cooling and resultant shrinking of the moldable material, the compression of the O-ring seal 18 is partially relieved and the O-ring seal 18 expands, but the O-ring seal 18 remains, once the moldable material has fully cooled, under sufficient compression as to provide a substantially fluid-tight seal between the inner end portion 15 of each tube 11, 12, 13 and 14 and the respective socket 22 of the housing 21. The further radially outwardly projecting rib 19 of the inner end portion 15 of each tube 11, 12, 13 and 14 is also encapsulated by the molded material of the respective socket 22 of the housing 21 mechanically to secure the inner end portion 15 of each tube 11, 12, 13 and 14 to the respective socket 22 of the housing 21. The encapsulation of the rib 19 of the inner end portion 15 of each tube 11,12, 13 and 14 by the molded material of the respective socket 22 of the housing 21 also has the beneficial effect of providing a relatively long and tortuous leak path for any fluid which tries to leak past the O-ring seal 18.

By the use of appropriate core molds during the injection molding of the housing 21, this housing 21 is formed with a hollow interior 23 within which may be provided a bypass valve 29. Bypass valve 29 is described further in U.S. Pat. No. 6,253,837 (Seiler et al.), which is herein incorporated by reference. The inlet feed oil tube 11 may be operatively connected by the feed oil line 24 to, for example, a heat exchanger (not shown) in which the oil, for example transmission oil, may have been cooled. The outlet feed oil tube 12 may be operatively connected by the feed oil line 25 to an automotive engine denoted by the reference numeral 26. The engine 26 may be connected by the return oil line 27 to the inlet return oil tube 13, and the outlet return oil tube 14 may be connected by the return oil line 28 to the heat exchanger for cooling of the oil. Different materials may, of course, be used for the tubes 11, 12, 13 and 14 and for the housing 21 where different oils or other fluids are used with insert molded structure 10.

Under normal operating conditions of the engine 26, the inlet feed oil tube 11 is in communication through the housing 21 with the outlet feed oil tube 12, and the inlet return oil tube 13 is in communication through the housing 21 with the outlet return oil tube 14 so that oil may flow from the heat exchanger to the engine 26 and back from the engine 26 to the heat exchanger. During this normal operation of the engine 26, bypass valve 29 is in contact with a valve seat 30 in the housing 21 thereby preventing communication through the housing 21 between the return oil tubes 13, 14 and the feed oil tubes 11, 12. However, during, for example, start-up of the engine when the return oil does not require cooling, the bypass valve 29 is activated thereby, moving the bypass valve member 29 under the influence of spring 31 and against the influence of spring 32 away from the valve seat 30 (as shown in FIG. 1), so that oil may pass through the housing 21 from the inlet return oil tube 13 to the outlet feed oil tube 12, thus bypassing the heat exchanger.

Although the materials of the tubes 11, 12, 13 and 14 and of the housing 21 usually have different coefficients of thermal expansion, radial expansion of the O-ring seals 18 as the compression thereof is partially relieved ensures that, throughout the operative temperature range and the operative pressure range of the oil, there is provided a substantially fluid-tight seal between the inner end portion 15 of each tube 11, 12, 13 and 14 and the respective socket 22 of the housing 21.

While in the preferred embodiment of the invention hereinbefore described with reference to FIGS. 1 to 4, inclusive, of the accompanying drawings, there are four tubular members, namely, the tubes 11, 12, 13 and 14, together with the bypass valve 29 in the housing 21, it will be understood that in alternative embodiments of the invention there may be only one or any number of tubular members attached to the housing by the method hereinbefore described, and there need not be any bypass valve within the housing.

Depending on the fluid, which instead of transmission fluid or oil, could for example, be engine oil, power steering oil, hydraulic oil, diesel fuel, gasoline, coolant or air, and depending on the intended use of the insert molded structure 10, the temperature of the fluid may operatively vary over a considerable range of, for example, −40° C. to +260° C. Thus, for example, where the insert molded structure is a molded plastic tank manifold for a charge air cooler used on a turbocharged automotive engine, heated air provided to the tank manifold may be at a temperature of +260° C.

Referring now to the embodiment of the invention shown in FIG. 5, 33 denotes an insert member constituted by a tubular member the form of which corresponds generally to the form of each of the tubes 11, 12, 13 and 14 with the same reference numerals being used to denote the parts of the tubular member 33 corresponding to the parts of each of the tubes 11, 12, 13 and 14. It will be noted, however, that in the tubular member 33, the inner end portion 15 of the tubular member 33 extends inwardly with an inner end 34 being angled. Furthermore, in the embodiment of FIG. 5 the wall which in the embodiment hereinbefore described with reference to FIGS. 1 to 4, inclusive, is constituted by each of the sockets 22 of the housing 21, is instead constituted by a transition plate or wall 35 which is of moldable material and which may, for example, be of circular or square shape, the moldable material being injection molded partially to encapsulate an O-ring seal 36 corresponding to the O-ring seal 18, with the O-ring seal 36 under radial compression, in a manner corresponding to that hereinbefore described with reference to FIGS. 1 to 4, inclusive.

The transition wall 35 is provided with a peripheral land 37 which operatively abuts the peripheral portion of another wall 38 of, for example, a manifold surrounding an opening 39 in the wall 38, the wall 38 being of a plastic material with the land 37 being jointed to the peripheral portion of the wall 38 by, for example, vibration, thermal or ultrasonic welding. As shown in FIG. 5, the inwardly extending end portion of the tubular member 33 may abut an opposed wall 40 of the manifold in order accurately to position the tubular member 33. The transition plate or wall 35 may also be provided with an opposed peripheral land 41 so that, if desired the transition wall 35 may be joined to a further wall on the opposite side of the transition wall 35.

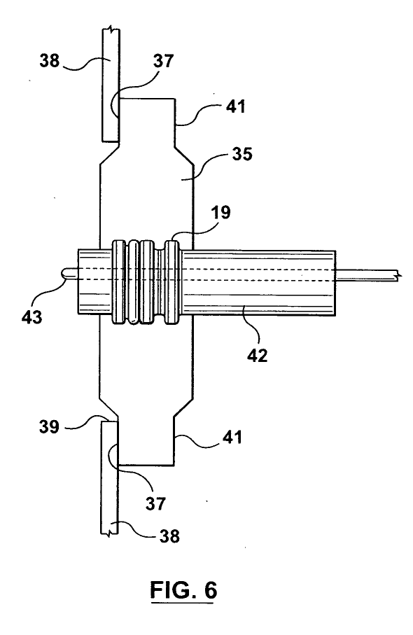

The embodiment shown in FIG. 6 differs from the embodiment hereinbefore described with reference to FIG. 5 in that the insert member is constituted by a solid metal rod 42 in which is embedded a component such as, for example, a temperature sensor 43. Alternatively, the insert member could, for example, be a tubular member the inner end of which is closed. For example, a temperature sensor may be disposed within the tubular member.

It will be appreciated that the rib 19 may be omitted. Furthermore, while in the embodiments of the invention as hereinbefore described with reference to the drawings the wall constituted by the sockets 22 of the housing 21 and the transition plate or wall 35 are described as being injection molded, this wall could, for example, be compression molded.

1. An insert molded structure comprising: an insert member having an inner end portion, a compressed O-ring seal mounted on said inner end portion, and a wall formed of a molded material which partially encapsulates the O-ring seal and said inner end portion and which maintains the O-ring seal in compression.

2. An insert molded structure according to claim 1, wherein the wall comprises a wall portion of a housing.

3. An insert molded structure according to claim 1, wherein the wall is constituted by a transition wall.

4. An insert molded structure according to claim 3, wherein the transition wall has a peripheral land adapted to be joined to a peripheral portion of a further wall of molded material surrounding an opening therein.

5. An insert molded structure according to claim 1 wherein the insert member is of metal.

6. An insert molded fitting according to claim 1 wherein the insert member comprises a tubular member.

7. An insert molded structure according to claim 3 wherein the insert member comprises a solid rod in which a component is embedded.

8. An insert molded structure according to claim 1 wherein the O-ring seal is in radial compression.

9. An insert molded structure according to claim 8 wherein said inner end portion of the insert member has two radially outwardly projecting ribs, the O-ring seal being disposed between said ribs.

10. An insert molded structure according to claim 9 wherein said inner end portion of the insert member has at least one further radially outwardly projecting rib which is spaced longitudinally from said two radially outwardly projecting ribs and which is at least partially encapsulated by the molded material.

11. An insert molded structure according to claim 1 wherein the molded material is formed of a plastic material.

12. An insert molded structure as claimed in claim 1 and further comprising:
a housing defining said wall;
a by-pass valve located in the housing;
an inlet feed oil tubular member, an outlet feed oil tubular member, an inlet return oil tubular member, and an outlet return oil tubular member;
each tubular member having an end portion, and a compressed O-ring seal on said end portion;
the molded material of the housing partially encapsulating the O-ring seals and said end portions of the tubular members and maintaining the O-ring seals in compression; and
the by-pass valve being operable between a first condition in which the inlet feed oil tubular member is in communication through the housing with the outlet feed oil tubular member and the inlet return oil tubular member is in communication through the housing with the outlet return oil tubular member but communication is blocked through the housing between the return oil tubular members and the feed oil tubular members, and a second condition in which the inlet return oil tubular member is in communication through the housing with the outlet feed oil tubular member.

13. A method of attaching an insert member to a wall, comprising the steps of: providing an insert member having an inner end portion, mounting an O-ring seal on said inner end portion, and forming the wall by molding material around the O-ring seal to partially encapsulate and compress the O-ring seal and maintain the O-ring seal in compression.

14. A method according to claim 13 wherein the insert member is of metal.

15. A method according to claim 14 wherein the insert member comprises a tubular member.

16. A method according to claim 13 wherein the O-ring seal is in radial compression.

17. A method according to claim 13 wherein the molded material is a plastic material.

18. A method according to claim 17 wherein the wall is formed by injection molding the plastic material around the O-ring seal.

19. A method according to claim 17 wherein the plastic material is a thermoplastic material.

20. A method according to claim 13 and further comprising the steps of:
providing three additional insert members, so that the four insert members constitute an inlet feed oil tubular member, an outlet feed oil tubular member, an inlet return oil tubular member, and an outlet return oil tubular member, each tubular member having an inner end portion;
mounting an O-ring seal on said inner end portion of each tubular member;
forming a housing defining said wall by injection molding material around the O-ring seals to partially encapsulate and compress the O-ring seals and maintain the O-ring seals in compression.
